(19) United States
(12) Patent Application Publication
(10) Pub. No.: US 2026/0198457 A1
(43) Pub. Date: Jul. 16, 2026

(54) SYSTEM WITH INTEGRATED HAPTIC FEEDBACK FOR CANINE COMMUNICATION

(71) Applicant: Steven Spungin, Marblehead, MA (US)

(72) Inventor: Steven Spungin, Marblehead, MA (US)

(21) Appl. No.: 19/396,418

(22) Filed: Nov. 21, 2025

Related U.S. Application Data
(60) Provisional application No. 63/745,829, filed on Jan. 16, 2025.

(51) Int. Cl. A01K 27/00; A01K 15/02; G08B 6/00

(52) U.S. Cl. CPC A01K 27/00; A01K 15/021; G08B 6/00

(57) ABSTRACT

The present disclosure relates to a system for providing non-correctional haptic feedback to enhance communication with a recipient, such as a dog, through a leash or collar. The system delivers periodic pulses at adjustable frequencies, ensuring the signal is perceived as an indicator rather than a correction. It adapts dynamically to changes in leash length and allows customization of feedback parameters. The system can also collect usage data for analytics and optimization. Designed to integrate seamlessly with various leash configurations, it supports improved interaction without interfering with other training signals or inducing discomfort.

### TECHNICAL FIELD

The present invention relates to systems and methods for animal communication, and more particularly to a system with integrated haptic feedback for canine communication.

### BACKGROUND ART

The system provides non-correctional feedback via a leash or collar to indicate to a recipient, such as a dog, that they are approaching a predetermined leash distance. Unlike traditional systems that use corrective signals to modify behavior, the present invention is designed to convey continuous, neutral feedback that does not induce discomfort, disorientation, or a need to alter behavior. The invention also ensures that the feedback signal does not interfere with or override other training messages that employ corrective stimuli such as vibration, sound, spray, or static feedback. While minimizing pulling may occur as a secondary benefit, the primary objective is to enhance leash-based communication without triggering aversive responses.

### SUMMARY OF THE EMBODIMENTS

In accordance with the present disclosure, embodiments of the invention provide various implementations of a system with integrated haptic feedback for canine communication. The system is designed to deliver a non-correctional signal to indicate when a recipient has reached a predetermined distance before reaching the extent of a leash's range, with multiple embodiments enabling flexibility in operation and integration. The invention also applies to scenarios in which the dog is leashed to a fixed object, such as a post, stake, railing, or fence, where the system continues to provide non-correctional feedback independent of a handler's direct involvement.

In some embodiments, the haptic signal is generated by altering the length of the leash or by employing an electro-mechanical mechanism. Additionally, the signal may be enabled by the tension on the leash, utilizing the physical dynamics between the leash and the recipient. In some instances, the signal may be enabled by the orientation of a device placed on the leash, handle, or collar. Alternatively, the signal may be enabled by detecting the distance of the leash from the operator to the collar through wireless or physical means. In certain configurations, the haptic signal is continuous and transmitted solely through the physics of tension on the leash, without requiring additional mechanical or electronic components.

The system can be integrated directly into the leash itself, allowing for seamless operation without external attachments. In other configurations, it may be integrated into the collar, enabling direct communication with the recipient, or incorporated into a leash handle for convenient adjustment and operation by the handler. The invention may also function as an attachment to existing leashes, positioned between the leash and the handle, between sections of the leash, or between the leash and the collar, offering retrofitting flexibility.

Additionally, the system may include features for manual or automatic adjustment of signal parameters, such as frequency, intensity, and envelope, based on the amount or frequency of tension on the leash, detected distance, speed or orientation of the device. Data collection capabilities may also be incorporated, enabling the system to gather analytics, generate progress reports, and optimize signal adjustments. Such data may include metrics like the frequency and intensity of signals, as well as leash tension, detected distance, speed and device orientation, providing valuable insights into usage patterns and facilitating ongoing improvement.

It should be noted that the term “frequency” as used herein refers to the frequency between successive pulses (i.e., the envelope or cadence of the pulse sequence), rather than the internal vibration frequency of the haptic actuator itself.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the device and method shown where illustration is not necessary to allow those of ordinary skill in the art to understand the device and method.

### BRIEF DESCRIPTION OF THE DRAWINGS

The preceding summary, as well as the following detailed description of the disclosed system and method, will be better understood when read in conjunction with the attached drawings. It should be understood, however, that neither the device nor the method is limited to the precise arrangements and instrumentalities shown.

FIG. 1A illustrates a bottom perspective view of an embodiment of the system of the present disclosure, showing a device for dynamically adjusting the length of a leash, highlighting features for transmitting haptic feedback through the leash.

FIG. 1B presents a top perspective view of the embodiment shown in FIG. 1A.

FIG. 2A depicts a bottom perspective view of another embodiment of the system, where tension on the leash activates a haptic feedback mechanism integrated into the device.

FIG. 2B is a top perspective view of the embodiment shown in FIG. 2A.

FIG. 3 provides a schematic illustration of an embodiment utilizing an electromagnet to adjust leash length and deliver haptic feedback regardless of leash tension.

FIG. 4A illustrates an embodiment of the system of the present disclosure featuring a clip with a level detector that activates a haptic engine to emit signals based on the clip's angle, independent of leash tension.

FIG. 4B is a schematic view of the internal components of the clip housing of FIG. 4A, illustrating a level detector, a power supply, a control unit, and a haptic engine disposed within the housing.

FIGS. 5A-5C illustrate representative signal and event data recorded during operation of the angle-based embodiment of FIG. 4, wherein FIG. 5A shows an example angle-derived distance estimate between the leash handle and the recipient as a function of time, including upper and lower thresholds defining the hysteresis region for activation and deactivation of the periodic haptic signal; FIG. 5B shows the corresponding binary pulse-control state, indicating the ON and OFF intervals generated by the hysteresis-gated control logic; and FIG. 5C shows discrete TUG events detected from accelerometer data, which represent physical leash pulls; in the illustrated embodiment, emission of the periodic signal is temporarily suppressed during such events because the leash tension itself provides tactile feedback.

### DETAILED DESCRIPTION OF SPECIFIC EMBODIMENTS

Specifically, the present disclosure provides a series of pulses that are conducted through a leash or collar to the recipient, such as a dog. These pulses are modeled to simulate a gentle and rhythmic stimulus akin to a series of light tugs or the natural swinging motion of an arm. The present disclosure is designed to convey this feedback in a manner that is intuitive for the recipient, enhancing communication between the handler and the animal without inducing discomfort or correction.

The present disclosure operates on the principle that recipients, such as dogs, are more likely to pull against a leash when steady tension is applied without the accompaniment of a periodic pulse. A constant signal, whether auditory, haptic, or otherwise, that lacks periodic variation is typically perceived as corrective rather than as an indicator. To avoid this misinterpretation, the present disclosure incorporates a periodic pulse that falls within an effective frequency range of 0.75 to 6 Hertz, with a preferable operating frequency of approximately 2 to 3 Hertz. This specific range ensures the pulses are perceivable and distinguishable without being disruptive or confusing.

One of the unique features of the present disclosure is its ability to dynamically adjust to changes in leash length without requiring any manual recalibration or adjustments by the user. This capability allows the system to maintain the consistency of its periodic pulses regardless of how the leash is manipulated during use. By adapting to varying leash lengths, the present disclosure ensures that the feedback remains intuitive and effective, regardless of the handler's movements or the recipient's position.

The system of the present disclosure delivers a signal through the leash that is designed to simulate the motion of a “bouncing arm” or a “tugging wrist,” utilizing either physical dynamics or electromechanical mechanisms. This signal is carefully modeled to provide a rhythmic, non-correctional feedback that is intuitive and natural for the recipient. By mimicking the gentle and familiar motion of a handler's arm or wrist, the signal ensures that it is perceived as an indicator rather than a correction. Importantly, the design of the system ensures that this feedback does not interfere with other training stimuli, such as vibrations, sound, or static corrections, maintaining the integrity and clarity of separate training cues. This approach enhances communication between the handler and recipient while supporting broader training objectives.

Overall, the present disclosure provides a novel method for delivering non-correctional feedback through a leash or collar, using carefully modeled pulses to improve communication while avoiding the pitfalls of steady or constant signals. This approach is intended to support a positive interaction between the handler and the animal, enhancing the leash-based experience for both parties.

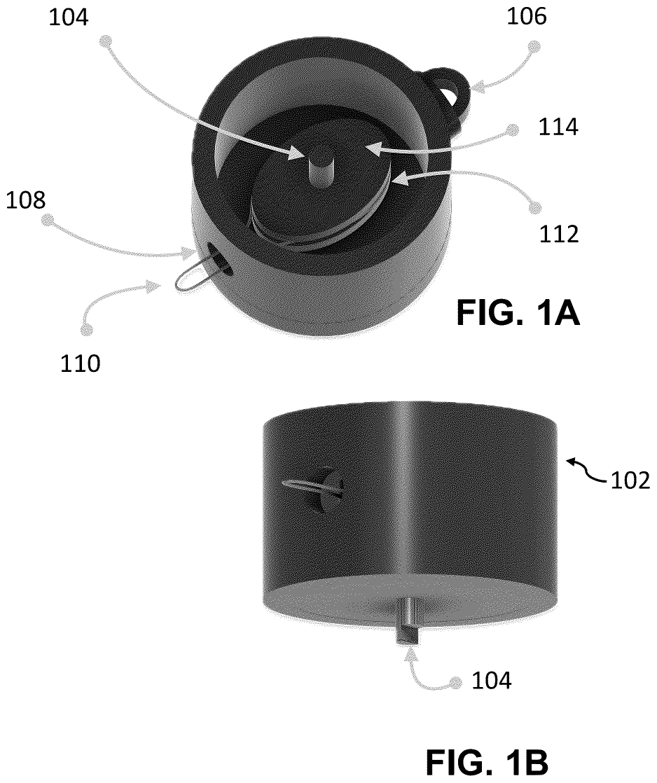

FIG. 1A illustrates a bottom perspective view of an embodiment of the system of the present disclosure, wherein the physical length of the leash can be adjusted using a device positioned between a handle and a leash, a leash and another leash, or a leash and a collar. This design facilitates dynamic changes in leash length without requiring a tension switch. The embodiment features a housing that encloses the functional components, including a driveshaft and a connector, which can interface with the leash, collar, or handle, an exit port for the wire loop, which is a critical component for transmitting haptic signals. Also visible are the driveshaft, a channel designed to guide the wire loop, a cam mechanism for adjusting the wire loop, a connector that interfaces with the leash, collar, or handle, and a length changing wire loop for attaching to the connector for leash, collar, or handle. Together, these components enable the system of the present disclosure to provide continuous, non-correctional haptic feedback to the recipient while dynamically managing leash length. Furthermore, altering the shape of the cam will allow for changing the envelope of the signal. FIG. 1B is a top perspective view of the system of FIG. 1A, showing the wire loop and the drive shaft disposed in the housing.

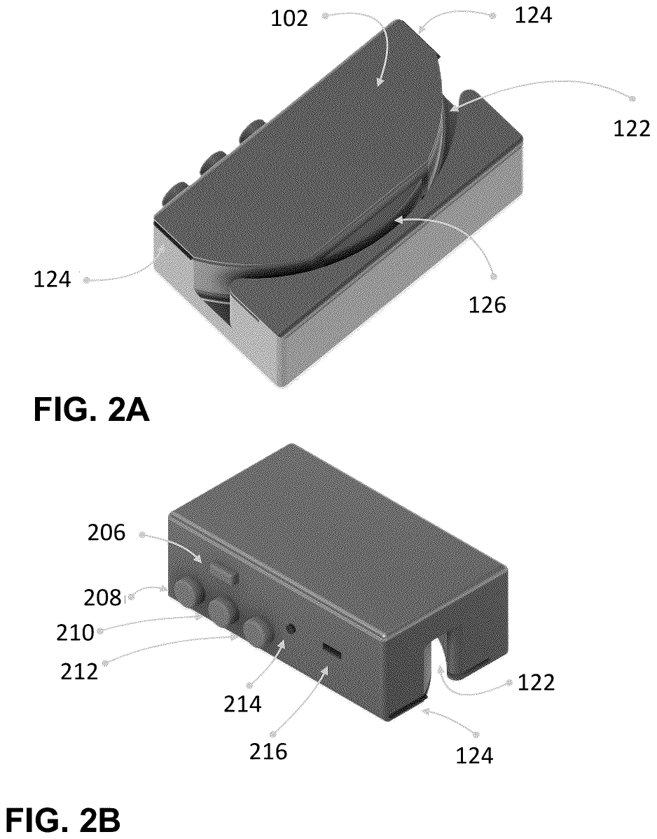

FIG. 2A illustrates a bottom perspective view of another embodiment of the system of the present disclosure. This embodiment features a housing that encloses the power supply, haptic engine, and control unit. It also includes a leash channel for guiding the leash, a sliding leash channel retainer, such as a cover or slider, to securely hold the leash within the channel, enhancing stability without interfering with the functionality of the system of the present disclosure. The housing further includes a tension detector for monitoring leash dynamics and activating the haptic feedback system accordingly. This configuration ensures effective operation while maintaining a compact and user-friendly design.

FIG. 2B illustrates a top perspective view of the embodiment shown in FIG. 2A. This view highlights additional features, including a power and mode switch, a tension sensitivity control dial, an intensity control dial, a frequency control dial, and a status indicator for system monitoring. The embodiment also includes a USB interface and power input for recharging or powering the device and adjusting parameters. The leash channel and its sliding retainer are also visible, providing a secure and adjustable mechanism for accommodating the leash while ensuring seamless operation of the system. This configuration offers enhanced usability and precise control for the handler. One significant advantage of this design is that it does not compromise the structural strength of the leash, ensuring safe and reliable operation, such as a cover or slider, to securely hold the leash within the channel, enhancing stability without interfering with the functionality of the system of the present disclosure.

Another embodiment of the system of the present disclosure eliminates the tension detector and instead emits the haptic signal continuously. In this configuration, the device is positioned on the operator side of the leash. The recipient detects the signal only when the leash begins to experience tension, as the physical dynamics of the leash transmit the signal through the applied force.

This design offers advantages such as reduced production costs and simpler construction while maintaining the core functionality of delivering non-correctional feedback to the recipient. It provides an alternative implementation that aligns with the objectives of the present disclosure.

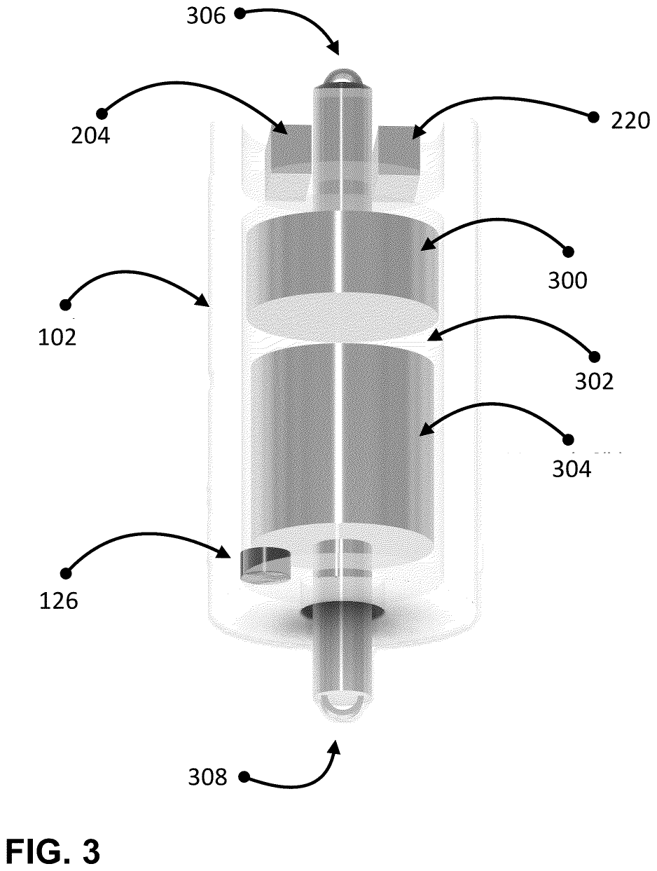

FIG. 3 is a schematic illustration of another embodiment of the system of the present disclosure. This embodiment includes a current control unit, a stationary coupling, a power supply, an electromagnet (stationary), a slider channel, a magnetic slider, a tension detector, a moving coupling, and a transparent housing to showcase the internal components.

This embodiment utilizes an electromagnet to adjust the length of the leash dynamically, providing precise and responsive operation. Additionally, the system can generate and transmit a haptic signal through the leash, even when the tension on the leash prevents its length from being adjusted. This dual functionality ensures the system of the present disclosure remains effective in delivering haptic feedback while retaining its capacity for dynamic leash length control under various conditions.

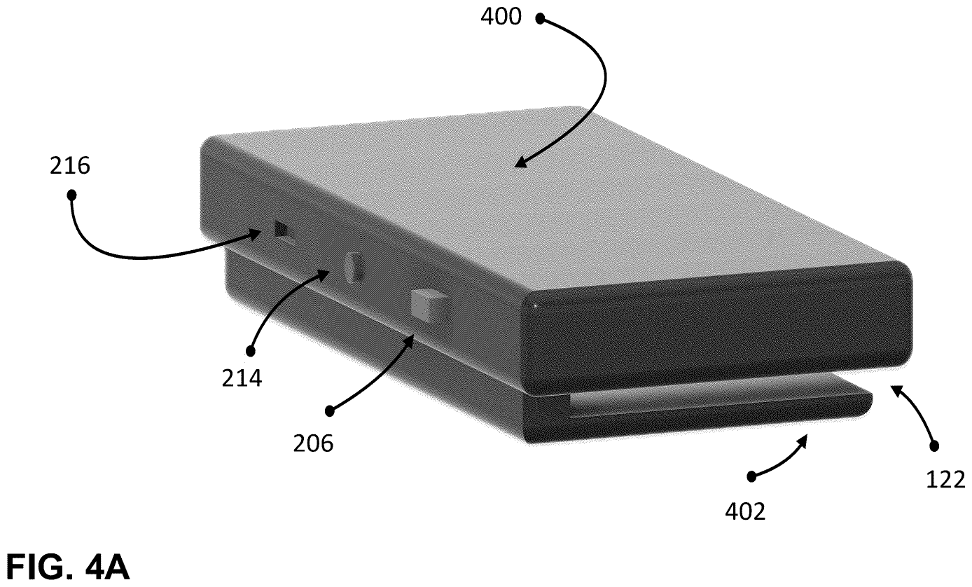

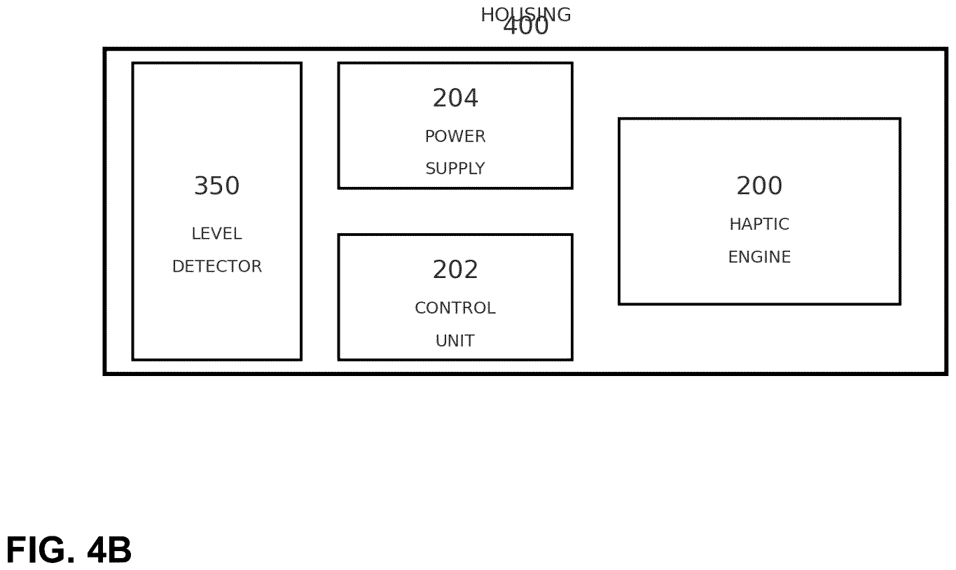

FIG. 4 illustrates an embodiment of the system of the present disclosure that operates independently of leash tension. This embodiment features a clip designed to attach to the operator side of the leash. This embodiment may be attached to either the collar side or the operator side of the leash, and in some implementations may be particularly effective when positioned adjacent the collar, as placement closer to the recipient can reduce transmission losses that may occur along the length of the leash. The clip incorporates a level detector that activates the haptic engine when the clip's angle exceeds a predefined threshold, simulating a natural feedback signal. The housing of the clip contains essential components, including a level sensor, power supply, haptic engine, and control unit. Additional features include a USB interface for power input and charging as well as setting configurations and managing logs, a status light for system monitoring, a power switch, a leash clip, and a leash channel to securely hold the leash in place. This embodiment offers a compact and self-contained design, providing effective feedback without relying on tension-based activation and without interfering with the structural integrity of the handles, leash, and collar.

In an alternative embodiment of the system of the present disclosure, the functionality of the FIG. 4 embodiment can be reproduced using a mobile phone equipped with a gyroscope and/or accelerometer and a haptic unit, features standard in most modern smartphones. In this configuration, the mobile phone could serve as the primary device for detecting, generating, and delivering, haptic feedback and movement. The phone would be secured in a specially designed case or clip that attaches to the leash, handle, or collar, allowing it to remain stable and aligned with the system during use.

The system of the present disclosure, as illustrated in FIGS. 1A-4, comprises a series of embodiments configured to provide non-correctional haptic feedback to a recipient through a leash or collar. In the embodiment of FIGS. 1A-1B, a housing 102 encloses a drive shaft 104 and cam 114, which cooperate with a wire loop 110 guided by channel 112 and exiting through port 108 toward a connector 116. This configuration allows dynamic adjustment of leash length and transmission of a rhythmic feedback signal through the leash. The embodiment of FIGS. 2A-2B incorporates a leash channel 122 with a sliding retainer 124, and a tension detector 126 within the housing 102, which activates a haptic engine 200 (not shown) and is controlled by a control unit 202 (not shown) and powered by a power supply 204 (not shown). User controls may include a power and mode switch 206, tension sensitivity control 208, intensity control 210, frequency control 212, status indicator 214, USB interface 216, and a power input 218 (not shown), enabling fine adjustment of signal parameters and power management. The embodiment of FIG. 3 features a current control unit 220 that drives a stationary electromagnet 300 within a slider channel 302, producing motion of a magnetic slider 304 between a stationary coupling 306 and a moving coupling 308, all enclosed in a transparent housing 102. This arrangement enables both leash-length control and haptic signal generation through electromagnetic actuation. The embodiment of FIG. 4 provides an alternative clip-based system including a clip housing 400, a level detector 350 (not shown), a haptic engine 200 (not shown), a control unit 202 (not shown), and a power supply 204 (not shown), with a power switch 206, status light 214, USB interface 216, and leash clip 402 configured around a leash channel 122. The level detector in this embodiment activates the haptic feedback when the clip angle exceeds a preset threshold, providing intuitive, motion-based feedback independent of leash tension. In each embodiment, components identified as “not shown” may be enclosed within the housing for clarity of illustration while remaining functionally present in the described system. Collectively, the embodiments of FIGS. 1A-4 illustrate variations of a unified system that delivers non-correctional, periodic haptic feedback through mechanical, electromagnetic, or angle-based activation, thereby enhancing communication between the handler and the recipient without inducing discomfort or corrective association

By running a dedicated mobile application, the phone could detect changes in angle or orientation using its built-in gyroscope, also the accelerometer and gps to detect tugs and distance walked, and location based settings and process these inputs to determine when the angle exceeds a preset threshold. Upon detecting this condition, the application would activate the phone's haptic unit to emit the desired feedback signal, simulating the gentle, rhythmic motion described in the system's design. The application could also allow for user customization of signal parameters such as frequency, intensity, and duration, providing flexibility to accommodate different training needs and recipient sensitivities.

This embodiment leverages the versatility and advanced hardware of smartphones, eliminating the need for separate custom components like a standalone level detector or haptic engine. Additionally, it enables easy updates and enhancements to the system through application updates, as well as the ability to log and analyze data collected during use. For example, the application could store information on distance, leash tension patterns or feedback frequency, offering insights into training progress and system performance. This mobile phone-based alternative provides a cost-effective and highly adaptable solution, expanding the accessibility and practicality of the system of the present disclosure.

To build upon the stated embodiment, FIG. 4 could be further enhanced to accommodate the integration of a mobile phone, utilizing one or more of its built-in features, such as the gyroscope, haptic engine, accelerometer, power supply, data storage, data processing, and connectivity to complement or extend the capabilities of the system. In this configuration, the mobile phone could serve as a central processing and control unit while interacting with onboard components such as the haptic feedback generator or a length-altering mechanism integrated into the leash or clip.

The mobile phone's gyroscope could monitor changes in orientation or angle, functioning as a level detector to determine when specific conditions are met, such as a tilt beyond a preset threshold. Once triggered, the phone could send a command to the onboard haptic engine or length-altering mechanism to activate, delivering the desired feedback or adjusting the leash's length dynamically. This approach minimizes the need for additional sensors in the system, leveraging the highly accurate and sensitive hardware already present in modern smartphones.

The phone's power supply could be utilized to supplement or even replace the onboard battery of the device, reducing overall system weight and complexity. By connecting to the onboard components via a physical or wireless interface (e.g., Bluetooth or USB), the phone could provide a stable and rechargeable power source. Additionally, the phone's data storage capabilities would allow for the recording of system usage, such as the frequency of haptic signals, tension data, or angle detections. This data could then be processed locally on the phone or transmitted to a cloud-based system for more advanced analytics.

The integration of the phone's data processing capabilities offers a highly customizable platform for system operations. Through a dedicated app, users could control various parameters of the haptic feedback, such as intensity, frequency, and duration, or configure thresholds for the length-altering mechanism. The app could also include advanced features like real-time monitoring, historical data visualization, or automatic adjustments based on learned behavior patterns of the recipient.

Finally, the phone's connectivity features, including Wi-Fi, cellular data, or Bluetooth, could enable seamless communication with other devices or cloud services. This connectivity would allow for remote operation, firmware updates, or integration with other smart systems, such as wearable technology or home automation systems. For example, the system could send alerts or updates to the user's other devices or synchronize with training schedules stored on the phone.

By incorporating a mobile phone into the FIG. 4 embodiment, this enhanced system design achieves greater flexibility, functionality, and user convenience while reducing the reliance on proprietary components. This approach effectively transforms a smartphone into a versatile hub that complements the onboard haptic and length-altering devices, creating a highly adaptive and scalable system.

This enhanced embodiment, leveraging the integration of a mobile phone, can also be applied to other embodiments of the present disclosure. By utilizing the phone's built-in features—such as the gyroscope, accelerometer, power supply, data storage, data processing, and connectivity—it can seamlessly integrate with onboard haptic feedback systems or length-altering mechanisms in these alternative configurations.

For instance, in embodiments where the haptic feedback system is designed to provide periodic signals through the leash, the mobile phone's gyroscope could enhance precision by detecting finer movements or angles of the leash or device. The phone could process these inputs in real time, triggering the haptic engine to deliver feedback with greater accuracy and customization. Similarly, in embodiments where the system dynamically adjusts the length of the leash, the phone's data processing capabilities could enable smarter, adaptive control of the length-altering mechanism based on learned patterns, tension dynamics, or user-defined parameters.

The mobile phone's power supply could supplement or even replace the power requirements of these embodiments, reducing the need for bulky batteries in the onboard system. Data storage and processing would allow the phone to collect and analyze detailed usage statistics across multiple training sessions or scenarios, providing users with valuable insights into the recipient's behavior and training progress. Furthermore, connectivity features such as Bluetooth or Wi-Fi could facilitate integration between the system and other devices, allowing remote operation, real-time monitoring, or synchronization with smart training aids or cloud-based analytics platforms.

This ability to integrate the mobile phone with onboard haptic feedback or length-altering devices enhances the functionality and adaptability of the various embodiments of the present disclosure. It not only broadens the scope of the system's applications but also simplifies the design by utilizing widely available and familiar technology, creating a robust, cost-effective, and user-friendly solution for handlers and recipients alike. In one implementation, the mobile phone can also utilize its built-in haptic capabilities to generate the periodic feedback signal, thereby replacing all functional components of the embodiment illustrated in FIG. 4 and operating as the primary signal-generating device within the system.

In one implementation of the embodiment illustrated in FIG. 4, a level detector (350) disposed within the housing (400) measures an angle θ of the leash relative to gravity. The control unit (202) receives angle data from the level detector and maps θ to an estimated leash distance, for example using a calibrated effective length L_eff to compute a distance estimate d_est=f(θ) (e.g., d_est=L_eff·sin θ). The control unit applies hysteresis between an activation threshold (D_ON) and a deactivation threshold (D_OFF) to prevent chattering between ON and OFF states. When d_est≥D_ON, the control unit actuates the haptic engine (200) to emit periodic signals; when d_est≤D_OFF, the control unit suspends signal emission. The control unit further monitors accelerometer data to detect tug events, which are characterized by transient, high-magnitude acceleration peaks. When a tug is detected, the periodic signals may be temporarily suppressed because the leash tension itself conveys a tactile indication to the recipient.

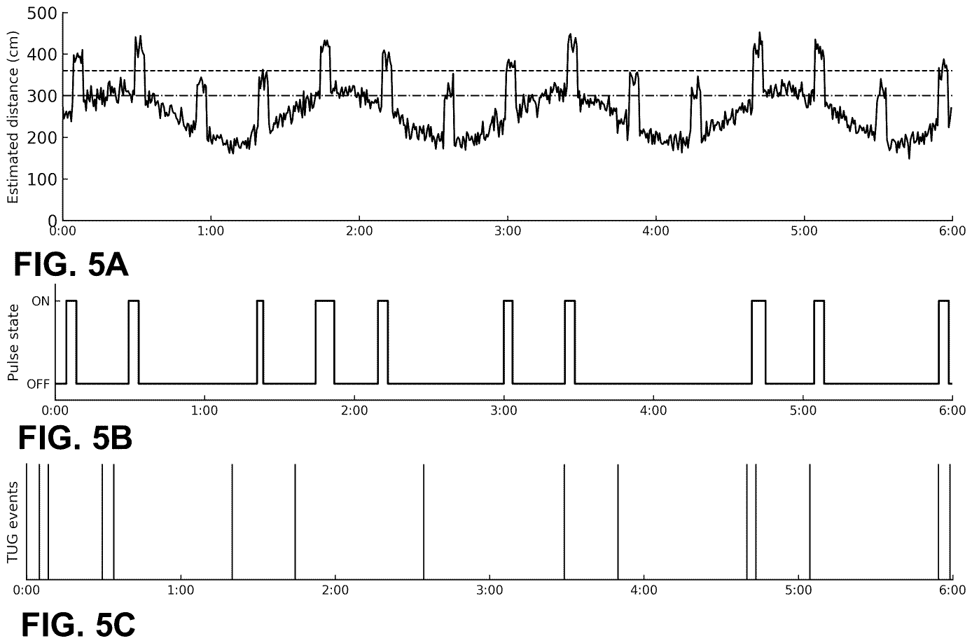

As illustrated in FIG. 5A, the estimated distance between the leash handle and the recipient is plotted as a function of time, showing the upper and lower hysteresis thresholds that define the activation and deactivation limits for the haptic output. FIG. 5B shows the corresponding pulse-control state, indicating when the periodic signal is active (ON) and when it is inactive (OFF). FIG. 5C depicts discrete tug events detected by the accelerometer, which correspond to physical leash pulls; in this embodiment, such events may cause temporary suppression of the periodic signal. The data of FIGS. 5A-5C were obtained during an example walk using the angle-based embodiment, demonstrating the functional relationship among the measured distance, the ON/OFF state transitions, and the detected tug events. Threshold values, filter parameters, and signal frequency or amplitude may be user-selectable or adaptively varied in operation, and the values represented in FIGS. 5A-5C are illustrative and non-limiting. The log data may also be used to compare different walks, evaluate system performance over time, and optimize configuration parameters for improved operation.

In certain embodiments, the control logic of the system may employ hysteresis-gated actuation, wherein separate activation and deactivation thresholds are defined in terms of either estimated distance or measured angle. This dual-threshold configuration ensures stable operation by preventing rapid oscillation between ON and OFF states when the measured value fluctuates near a single trigger point. The system may further incorporate tug-aware gating, wherein detection of a tug event, based on transient acceleration or motion spikes sensed by the accelerometer, causes the control unit to suppress or modify the emission of periodic pulses, allowing the natural leash tension to serve as the tactile feedback instead of the generated haptic signal.

In one configuration, the distance between the handler and the recipient is determined solely from the measured angle of the leash, thereby providing angle-only distance estimation that requires no tension sensor, Bluetooth communication, or optical or ultrasonic ranging components. The control algorithm may implement a state machine with lockout, in which transitions between the OFF and ON states are permitted only after specified timing or threshold conditions have been satisfied, thereby preventing rapid chattering or false triggers around the hysteresis limits.

In still other embodiments, the control unit may adjust its thresholds dynamically by employing adaptive thresholding, wherein recent motion statistics, leash length estimates, or historical angle data are analyzed to refine the activation and deactivation points in real time. The system may also provide user-settable parameters, enabling the handler to define thresholds, signal frequency, amplitude, intensity, and filter constants either through physical controls or via a software interface. Together, these control features enhance stability, responsiveness, and personalization of the feedback, while allowing the system to adapt to varying leash lengths, walking conditions, and recipient behavior patterns.

The functional relationships among these control features are exemplified in the data illustrated in FIGS. 5A-5C. As shown in FIG. 5A, the hysteresis-gated actuation establishes distinct activation and deactivation thresholds that define stable ON and OFF regions for the haptic signal, thereby preventing rapid toggling near the boundary conditions. FIG. 5B corresponds to the resulting pulse-control state and demonstrates the effect of the state machine lockout, in which the control unit transitions between signal states only when the distance estimate crosses the defined hysteresis limits. FIG. 5C illustrates the operation of tug-aware gating, where high-magnitude acceleration spikes—representing leash tugs—are detected by the onboard accelerometer, and the control unit suppresses the periodic signal during such events. Together, the traces in FIGS. 5A-5C demonstrate the coordinated interaction of hysteresis control, tug suppression, and adaptive signal management, validating that the system effectively distinguishes between normal leash motion and corrective tension, thereby providing a stable, non-correctional form of haptic communication.

Haptic engines suitable for the system of the present disclosure include various technologies that generate tactile feedback. Eccentric Rotating Mass (ERM) motors are a common choice, producing vibrations by spinning an unbalanced weight on a motor shaft. These motors are cost-effective, compact, and widely used in devices such as smartphones and wearables, making them ideal for generating the gentle, rhythmic vibrations required to simulate a “bouncing arm” or “tugging wrist.” Linear Resonant Actuators (LRAs) offer another option, using a magnetic mass attached to a spring, driven by an alternating current. LRAs are particularly effective for applications requiring precise control over vibration frequency and intensity, enabling customizable feedback for varying leash dynamics. Piezoelectric actuators, which utilize piezoelectric materials that deform under an electric field to create vibrations, provide a compact and efficient solution capable of producing high-frequency signals for more subtle feedback. Electromagnetic solenoids, which generate linear motion or vibrations by moving a magnetic core within a coil, are robust and well-suited for delivering tactile pulses that mimic a “tugging wrist” sensation.

Level sensors play a crucial role in detecting the orientation and movement of the clip in the system. Accelerometers, which measure changes in motion and orientation, are highly versatile and compact, making them ideal for detecting the angle of the clip and triggering the haptic engine when the threshold is exceeded. Tilt sensors, which use internal components like a ball or fluid to detect changes in angle, provide a simple and cost-effective solution for determining when the clip is angled sufficiently to activate feedback. Gyroscopes, which measure angular velocity, can provide precise information about rotational movements. When combined with accelerometers in an inertial measurement unit (IMU), gyroscopes enable highly accurate detection of the clip's orientation and motion. Optical level sensors, which rely on changes in light patterns or reflections within a sealed housing, are another option for precise angle detection, though they are less common. Together, these haptic engines and level sensors provide a range of reliable and effective components to support the functionality and versatility of the system.

The system of the present disclosure may include controls to adjust sensitivity and intensity, enabling customization to suit various users, recipients, and environments. Sensitivity controls allow the user to modify how the system detects and responds to changes in leash tension. For instance, a handler working with a smaller or more delicate dog might increase sensitivity so the system can detect even minor leash tension, whereas a handler working with a larger, stronger dog might decrease sensitivity to avoid unnecessary feedback from slight movements. Intensity controls, on the other hand, regulate the strength of the haptic feedback signals delivered to the recipient. A mild intensity setting may be appropriate for initial training or for animals that are more easily startled, while a higher intensity setting could be beneficial for more robust recipients or in scenarios where stronger signals are needed to ensure clarity. These controls may be implemented as physical dials or sliders on the device or as digital settings accessible through a mobile application, providing the user with flexibility and precision in tailoring the system's behavior. Together, sensitivity and intensity adjustments enhance the versatility and effectiveness of the system across a wide range of training and communication contexts. It should be noted that the term “frequency” as used herein refers to the frequency between successive pulses (i.e., the envelope or cadence of the pulse sequence), rather than the internal vibration frequency of the haptic actuator itself.

In accordance with another embodiment of the present disclosure, the system may incorporate advanced features such as IoT connectivity, Bluetooth functionality, and integrated sensors to further expand its capabilities and improve its utility. IoT connectivity allows the system to interface with a network, enabling remote tracking and data collection through a mobile or web-based application. This embodiment permits users to monitor various metrics in real-time, including leash tension patterns, signal frequency, and usage statistics. Such data can be analyzed to provide actionable insights into recipient behavior, training progress, and system performance, facilitating informed adjustments to the system's settings and enhancing overall efficacy.

Bluetooth functionality in this embodiment provides a seamless and wireless means of controlling the system's parameters, such as sensitivity, intensity, and signal frequency, duration and duty cycle through a dedicated mobile application. Users can also receive instant notifications regarding system diagnostics, such as battery life, connectivity status, or required maintenance. Bluetooth connectivity further simplifies firmware updates, ensuring that the system remains current with the latest features and improvements, thereby extending its usability and relevance.

Additionally, this embodiment may include advanced sensors to provide enhanced feedback and monitoring. Accelerometers and gyroscopes can detect sudden movements or jerks, enabling the system to adjust its feedback dynamically to suit the recipient's behavior or the handler's needs. Force sensors can measure leash tension with high precision, allowing the haptic feedback signals to respond accurately to varying levels of force. Temperature sensors may also be integrated to ensure safe operation in extreme environmental conditions, safeguarding both the handler and the recipient during outdoor use. In certain embodiments, the system may further incorporate a GPS module configured to determine location, measure distance traveled, and record positional data during use, thereby enabling enhanced logging, route comparison, and distance-based analysis for optimizing system performance and configuration.

These additional features make the system of the present disclosure more adaptable and intelligent, offering a personalized and user-friendly experience. By leveraging modern technologies, this embodiment enables integration with other smart devices, wearable technologies, and smart home ecosystems, significantly broadening the system's applications and enhancing its appeal to a wide range of users.

In additional embodiments, the triggering mechanisms and sensors described above may be incorporated independently into the collar, handle, or any coupling element of the system. For example, the angle sensor used in the leash-mounted embodiment may instead be positioned on the collar, with the measured orientation or angular deviation serving as the trigger for a signal generator located within the collar itself. In another configuration, a tension sensor integrated into the handle may detect leash tension and activate a signal generator positioned along the leash or at an intermediate location between the handle and the collar. In a further embodiment, a tension sensor may be incorporated directly into the collar, either at the leash-attachment point or distributed along the collar's perimeter, such that detected tension triggers a signal generated within the collar or within another component of the system. Although certain tension-sensing collars exist, they do not generate or modulate the periodic, non-correctional feedback signal defined herein. Similarly, a coupling positioned between any two components of the leash system—such as between two leash segments, or between the leash and the collar—may include a tension sensor that detects force transmission through the coupling and activates the signal generator accordingly. Existing inline couplings may sense tension, but they likewise do not produce the non-correctional periodic signal described in the present disclosure. These alternative placements of sensors and generators allow the system to be selectively configured or retrofitted to suit various leash, collar, and handle arrangements while maintaining the same underlying feedback principles.

In one embodiment, a system for providing haptic feedback for communication with a recipient includes a leash or tether configured to physically couple the recipient to at least one of an operator and a fixed object, a feedback mechanism configured to generate a series of periodic haptic signals that are perceptible to the recipient as a non-correctional indicator, a transmission interface associated with the leash or tether and configured to convey the periodic haptic signals through at least one of the leash or tether and a wearable device attached to the leash or tether to the recipient, and a control mechanism configured to monitor a distance parameter indicative of a separation between the recipient and at least one of the operator and the fixed object and to adjust one or more parameters of the periodic haptic signals based on the distance parameter. In such an embodiment, the periodic haptic signals are generated while the recipient approaches an extent of travel defined by the leash or tether and are configured to indicate to the recipient that the extent of travel is being reached. When the recipient progresses beyond the extent of travel such that the leash or tether becomes taut, the leash or tether provides a second physical feedback to the recipient in the form of a substantially steady pull resulting from sustained tension in the leash or tether, the second physical feedback being capable of occurring in combination with one or more additional signals produced by a separate training device. The system dynamically adapts to variations in the distance parameter without requiring manual adjustments and is configured such that the periodic haptic signals do not interfere with corrective training signals. In some implementations, the periodic signals have a frequency, such as a pulse repetition frequency, within a range of about 0.75 to 6 hertz, and in certain preferred versions the periodic signals have a frequency of about 2 to 3 hertz.

In various embodiments, the feedback mechanism can include at least one of an eccentric rotating mass motor, a linear resonant actuator, a piezoelectric actuator, an electromagnetic solenoid, an electromagnetically actuated slider, or a cam-driven mechanical actuator. The transmission interface can be integrated into at least one of a leash body, a collar, a harness, a leash handle, or an inline attachment positioned between two leash sections or between the leash and at least one of the collar, harness, or handle. The control mechanism can include one or more sensors selected from the group consisting of a tension sensor, an orientation sensor, a level or tilt sensor, and a distance or range sensor, and can be configured to derive the distance parameter and/or to trigger or modulate the periodic signals in response to a threshold or rate-of-change condition associated with one or more of the sensors. The system may further include a data collection module configured to log at least one of signal frequency, signal intensity, the distance parameter, leash tension, orientation, usage duration, location, velocity, acceleration, proximity, or recipient response metrics. In some variants, the control mechanism adjusts at least one of an amplitude, a pulse repetition frequency, an actuator vibration frequency, a duty cycle, or an envelope shape of the periodic signals based primarily on an estimated distance between the recipient and at least one of the operator and an anchor point, and optionally further based on a quantity derived from the distance, including a leash tension value and/or a time derivative of the distance. In another implementation, the system includes an electromagnetic slider assembly having a stationary electromagnet, a slider channel, and a magnetic slider, with the control mechanism configured to drive the electromagnet to produce motion of the slider that generates or transmits the periodic signals and/or adjusts an effective leash length or an effective maximum distance between the recipient and at least one of the operator and the anchor point. The system may also include a rechargeable power supply and a power and/or data interface configured for charging and/or firmware updates, and optionally a wireless interface configured to receive parameter updates from an external device.

In another embodiment, a system for providing haptic feedback independent of leash tension includes a housing configured to attach to an operator-side portion of a leash and including a leash-engaging structure, a level detector configured to sense an angle of the housing relative to gravity, a control unit operatively coupled to the level detector, and a haptic engine operatively coupled to the control unit and configured to generate a series of periodic signals that are conveyed through the leash to a recipient. In this embodiment, the control unit actuates the haptic engine to emit the periodic signals when the sensed angle exceeds a threshold and thereby provides non-correctional, angle-based feedback independent of leash tension. The leash-engaging structure can include a leash channel and a retainer configured to secure the leash within the housing. The level detector can include at least one of a tilt sensor, an accelerometer, a gyroscope, or a micro-electromechanical inertial measurement unit (IMU). The threshold may correspond to an angle of the housing relative to gravity, and the control unit may apply hysteresis to reduce chatter about the threshold. In some forms, the periodic signals have a frequency within a range of about 0.75 to 6 hertz, and the control unit can be configured to adjust at least one of signal amplitude, frequency, duty cycle, duration, or envelope based on user-selected settings. The system can further include a rechargeable battery and at least one of a wired charging port and a wireless charging interface disposed on the housing. In certain embodiments, the system further includes a wireless interface configured to communicate with a mobile device, the mobile device being operable to set the threshold, frequency, and intensity of the periodic signals and/or to log usage data. The system may also include at least one of a power switch and a status indicator disposed on the housing.

In a further embodiment, a system for providing haptic feedback for communication with a recipient includes a feedback mechanism configured to generate a series of periodic signals, the signals being perceptible to the recipient as a non-correctional indicator, a transmission interface configured to convey the signals through a leash, collar, or other wearable device to the recipient, and a control mechanism configured to adjust one or more parameters of the signals, where the system dynamically adapts to variations in leash length without requiring manual adjustments and does not interfere with corrective training signals.

### Angle-Based Distance Estimation

In certain embodiments, the system provides an angle-based distance estimation capability that can operate independently of any haptic feedback mechanism. A leash or tether physically couples the recipient, such as a dog, to an operator or a fixed anchor point. A sensor module is attached to an operator-side portion of the leash or tether and includes a level detector, such as an accelerometer, gyroscope, tilt sensor, or inertial measurement unit (IMU), configured to sense an angle of the leash or tether relative to gravity. A control unit receives angle data from the level detector and computes a distance parameter indicative of the separation between the operator (or anchor point) and the recipient. In one implementation, the control unit uses a calibrated effective length L_eff of the leash or tether and evaluates a function d_est=f(θ), where θ is the measured angle and f(θ) relates angle and length to an estimated distance. By way of example and not limitation, f(θ) may include a trigonometric relationship such as d_est=L_eff·sin(θ) or d_est=L_eff·cos(θ), optionally combined with correction factors for leash slack, handle height, or dynamic motion. The control unit can update the distance parameter at a regular sampling interval, providing a continuous or quasi-continuous estimate of leash distance over time.

The distance parameter computed in this manner may be used by the system for multiple purposes that do not require a haptic actuator. For example, the control unit may log the distance parameter over the course of a walk, enabling comparison of different walks or training sessions, evaluation of how often and how long the recipient approaches the leash extent, or analysis of movement patterns over time. The distance parameter can be combined with time, GPS data, or other sensor inputs to generate training analytics such as average working distance, frequency of near-limit excursions, or correlation between distance and recipient behavior. In some embodiments, the control unit or a connected device generates alerts or indications when the distance parameter exceeds a configurable limit, when the recipient remains beyond a specified distance for more than a threshold duration, or when the distance profile departs from a baseline pattern.

In other embodiments, the distance parameter serves as an input to adaptive control logic within a leash-based system. For instance, the system may adjust one or more operating thresholds, filter parameters, or control states—such as activation points for feedback, timeouts, or lockout conditions—based on recent statistics of the distance parameter. The system may also use the angle-derived distance estimate to coordinate operation of additional devices associated with the recipient, such as a collar-mounted training unit, a mobile phone secured to the leash or collar, or an automated retractable leash mechanism. In these configurations, the angle-based distance estimator provides a general-purpose distance signal that can be consumed by various hardware or software modules, regardless of whether any particular module generates haptic feedback.

Because the distance estimate is derived from angle measurements and one or more leash-related parameters, the system can operate without dedicated tension sensors, ultrasonic rangefinders, optical beacons, or Bluetooth ranging hardware. This allows the distance-estimation functionality to be implemented using inexpensive inertial sensors integrated into a compact operator-side module or into a mobile phone clip. The same angle-based distance computation may be used across different embodiments, including those that provide non-correctional haptic feedback, those that perform only data logging and analytics, and those that trigger non-haptic alarms or indicators, thereby enabling reuse of the distance-estimation engine in a wide variety of applications involving a tethered recipient.

The system of the present disclosure can be constructed from a variety of

materials selected to ensure durability, functionality, and user comfort while accommodating the needs of the recipient, such as a dog. Materials are chosen based on their strength, flexibility, weight, and environmental resilience, as well as their ability to integrate with the system's electronic and mechanical components.

For the housing of the system, lightweight and durable materials such as reinforced polymers, ABS plastic, or polycarbonate are ideal. These materials provide structural integrity, protecting the internal components from impact, moisture, and wear while remaining lightweight for ease of use. In scenarios requiring additional durability, such as for larger dogs or outdoor applications, aluminum or stainless steel may be employed, offering enhanced strength and corrosion resistance.

The leash and straps associated with the system are typically made of flexible yet strong materials such as nylon, polyester, or paracord, which offer high tensile strength and resistance to fraying. For applications requiring added flexibility or comfort, materials such as silicone or thermoplastic elastomers (TPE) can be used. These materials are also weather-resistant and easy to clean, making them suitable for prolonged outdoor use.

The electronic components, including sensors, haptic feedback mechanisms, and control units, are typically housed in compartments made of non-conductive materials such as plastic or resin to ensure electrical safety. The haptic feedback mechanism may utilize materials like silicone or rubber for components that come into contact with the leash or recipient, ensuring a comfortable and non-irritating interaction.

For the mechanical components, such as driveshafts, cams, or couplings, metals like stainless steel, aluminum, or titanium are preferred for their strength and resistance to wear. In some cases, engineered plastics like Delrin or PEEK (polyether ether ketone) can be used to reduce weight while maintaining mechanical integrity.

Finally, the power supply housing, such as for a rechargeable battery, USB charging port, or wireless charging interface, may incorporate waterproof seals and materials such as silicone gaskets to protect against moisture and dirt, thereby ensuring reliable performance in varied environmental conditions.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The foregoing detailed description is merely exemplary in nature and is not intended to limit the invention or application and uses of the invention. Furthermore, there is no intention to be bound by any expressed or implied theory presented in the preceding technical field, background, brief summary, or the following detailed description.

What is claimed is:

1. A system for providing haptic feedback for communication with a recipient, comprising:
a leash or tether configured to physically couple the recipient to at least one of an operator and a fixed object;
a feedback mechanism configured to generate a series of periodic haptic signals that are perceptible to the recipient as a non-correctional indicator;
a transmission interface associated with the leash or tether and configured to convey the periodic haptic signals through at least one of the leash or tether and a wearable device attached to the leash or tether to the recipient; and
a control mechanism configured to monitor a distance parameter indicative of a separation between the recipient and at least one of the operator and the fixed object and to adjust one or more parameters of the periodic haptic signals based on the distance parameter;
wherein the periodic haptic signals are generated while the recipient approaches an extent of travel defined by the leash or tether and are configured to indicate to the recipient that the extent of travel is being reached;
wherein, when the recipient progresses beyond the extent of travel such that the leash or tether becomes taut, the leash or tether provides a second physical feedback to the recipient in the form of a substantially steady pull resulting from sustained tension in the leash or tether, the second physical feedback being capable of occurring in combination with one or more additional signals produced by a separate training device; and
wherein the system dynamically adapts to variations in the distance parameter without requiring manual adjustments and is configured such that the periodic haptic signals do not interfere with corrective training signals.

2. The system of claim 1, wherein the periodic signals have a frequency within a range of 0.75 to 6 hertz.

3. The system of claim 2, wherein the periodic signals have a frequency of about 2 to 3 hertz.

4. The system of claim 1, wherein the feedback mechanism comprises at least one of: an eccentric rotating mass motor, a linear resonant actuator, a piezoelectric actuator, an electromagnetic solenoid, an electromagnetically actuated slider, or a cam-driven mechanical actuator.

5. The system of claim 1, wherein the transmission interface is integrated into at least one of: a leash body, a collar, a harness, a leash handle, or an inline attachment positioned between two leash sections or between the leash and at least one of the collar, harness, or handle.

6. The system of claim 1, wherein the control mechanism comprises one or more sensors selected from the group consisting of a tension sensor, an orientation sensor, a level or tilt sensor, and a distance or range sensor, and is configured to derive the distance parameter and/or to trigger or modulate the periodic signals in response to a threshold or rate-of-change condition associated with one or more of the sensors.

7. The system of claim 1, further comprising a data collection module configured to log at least one of: signal frequency, signal intensity, the distance parameter, leash tension, orientation, usage duration, location, velocity, acceleration, proximity, or recipient response metrics.

8. The system of claim 1, wherein the control mechanism adjusts at least one of an amplitude, a pulse repetition frequency, an actuator vibration frequency, a duty cycle, or an envelope shape of the periodic signals based primarily on an estimated distance between the recipient and at least one of the operator and the anchor point, and optionally further based on a quantity derived from the distance, including a leash tension value and/or a time derivative of the distance.

9. The system of claim 1, wherein the system comprises an electromagnetic slider assembly including a stationary electromagnet, a slider channel, and a magnetic slider, the control mechanism being configured to drive the electromagnet to produce motion of the slider that generates or transmits the periodic signals and/or adjusts an effective leash length or an effective maximum distance between the recipient and at least one of the operator and the anchor point.

10. The system of claim 1, further comprising a rechargeable power supply and a power and/or data interface configured for charging and/or firmware updates, and optionally a wireless interface configured to receive parameter updates from an external device.

11. A system for providing haptic feedback independent of leash tension, comprising:
a housing configured to attach to an operator-side portion of a leash and including a leash-engaging structure;
a level detector configured to sense an angle of the housing relative to gravity;
a control unit operatively coupled to the level detector; and
a haptic engine operatively coupled to the control unit and configured to generate a series of periodic signals that are conveyed through the leash to a recipient,
wherein the control unit actuates the haptic engine to emit the periodic signals when the sensed angle exceeds a threshold and thereby provides non-correctional, angle-based feedback independent of leash tension.

12. The system of claim 11, wherein the leash-engaging structure comprises a leash channel and a retainer configured to secure the leash within the housing.

13. The system of claim 11, wherein the level detector comprises at least one of a tilt sensor, an accelerometer, a gyroscope, or a micro-electromechanical inertial measurement unit (IMU).

14. The system of claim 11, wherein the threshold corresponds to an angle of the housing relative to gravity, and the control unit applies hysteresis to reduce chatter about the threshold.

15. The system of claim 11, wherein the periodic signals have a frequency within a range of 0.75 to 6 hertz.

16. The system of claim 11, wherein the control unit is configured to adjust at least one of signal amplitude, frequency, duty cycle, duration, or envelope based on user-selected settings.

17. The system of claim 11, further comprising a rechargeable battery and at least one of a wired charging port and a wireless charging interface disposed on the housing.

18. The system of claim 11, further comprising a wireless interface configured to communicate with a mobile device, the mobile device being operable to set the threshold, frequency, and intensity of the periodic signals and/or to log usage data.

19. The system of claim 11, further comprising at least one of a power switch and a status indicator disposed on the housing.

20. A system for providing haptic feedback for communication with a recipient, comprising:
a feedback mechanism configured to generate a series of periodic signals, the signals being perceptible to the recipient as a non-correctional indicator;
a transmission interface configured to convey the signals through a leash, collar, or other wearable device to the recipient; and
a control mechanism configured to adjust one or more parameters of the signals,
wherein the system dynamically adapts to variations in calculated distance without requiring manual adjustments and does not interfere with corrective training signals.

21. A system for estimating a separation between an operator and a tethered recipient, comprising:
a leash or tether configured to physically couple the recipient to at least one of the operator and a fixed object;
a housing configured to be attached to the leash or tether at a location between the operator or fixed object and the recipient;
a level sensor disposed in the housing and configured to sense an orientation of the housing relative to gravity;
a memory storing a leash-length parameter indicative of a distance between the housing and at least one of the operator and an anchor point; and
a processor operatively coupled to the level sensor and the memory and configured to determine an angle of the leash or tether relative to gravity based on the sensed orientation, compute an estimated separation between the operator or anchor point and the recipient as a function of the angle and the leash-length parameter, and generate a distance signal indicative of the estimated separation for use by one or more applications associated with at least one of the operator and the recipient.

22. The system of claim 21, wherein the housing further includes an accelerometer operatively coupled to the processor, and the processor is further configured to process accelerometer data to detect tug events characterized by transient changes in acceleration and to record or log the tug events in association with the distance signal over time.
